(19) United States
(12) Patent Application Publication
(10) Pub. No.: US 2003/0236702 A1
(43) Pub. Date: Dec. 25, 2003

(54) Anonymous electronic marketing method and system

(75) Inventor: Robert S. Hoblit, Knlghtdale, NC (US)

Correspondence Address: IBM Corporation, Personal and Printing Systems Group Legal Dept., Dept. 9CCA/Bldg. 002-2, P.O. Box 12195, Research Triangle Park, NC, 27709, US

(73) Assignee: International Business Machines Corporation, Armonk, NY

(21) Appl. No.: 10/177,978

(22) Filed: Jun. 21, 2002

(51) Int. Cl. G06F 17/60

(52) U.S. Cl. 705/14

(57) ABSTRACT

Aspects for anonymous electronic marketing are described. The aspects include detecting the presence of one or more articles of digital apparel from the consumer by a processing system. Identifying data of the one or more articles is utilized by the processing system to determine attributes of the one or more articles. Providing a profile of the consumer based on the attributes follows, and information is provided to the consumer based on the profile.

### FIELD OF THE INVENTION

The present invention is related to anonymous electronic marketing.

### BACKGROUND OF THE INVENTION

A factor in the ability to successfully deliver products to consumers is the knowledge by the consumer of the availability of a product. To that end, many businesses spend significant revenue on product advertising. For most consumers, many advertisements go largely ignored unless they match a particular personal interest or need. In order to better match the delivery of product information to desired consumers, some businesses try to market themselves to consumers who fit a particular profile, such as particular demographics of age, gender, marital status, and income. However, for most consumers, the potential for increased advertising is not always welcome and thus makes them reluctant to provide this type of information to market researchers who act to procure such data.

Further exacerbating their reluctance is the increase in advertising that bombards consumers on the Internet. While easing access to the market, the unsolicited and intrusive nature of most advertising to Internet users adds to their irritation and to their likelihood of ignoring the ads, whether pertinent or not to their interest or need. Thus, a challenge remains to match the needs and interests of consumers with the goods and services of businesses. The present invention addresses such a challenge.

### SUMMARY OF THE INVENTION

Aspects for anonymous electronic marketing are described. The aspects include detecting the presence of one or more articles of digital apparel from the consumer by a processing system. Identifying data of the one or more articles is utilized by the processing system to determine attributes of the one or more articles. Providing a profile of the consumer based on the attributes follows, and information is provided to the consumer based on the profile.

Through the present invention, the inclusion of the technology and processing into a kiosk or other such customer touch point, the customer can be more effectively marketed to without any prior relationship with the vendors and without disclosing any personal information. The profile provided presents an advantageous link between spending level and consumer preferences for certain types of products and the available businesses known in the kiosk and considered to closely match those preferences. These and other advantages of the present invention will be more fully understood in conjunction with the following detailed description and accompanying drawings.

### BRIEF DESCRIPTION OF THE DRAWINGS

FIG. 1 illustrates an anonymous electronic marketing system in accordance with a preferred embodiment of the present invention.

FIG. 2 illustrates a flow diagram of an anonymous electronic marketing process in accordance with a preferred embodiment.

### DETAILED DESCRIPTION

The present invention relates to an anonymous electronic marketing. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

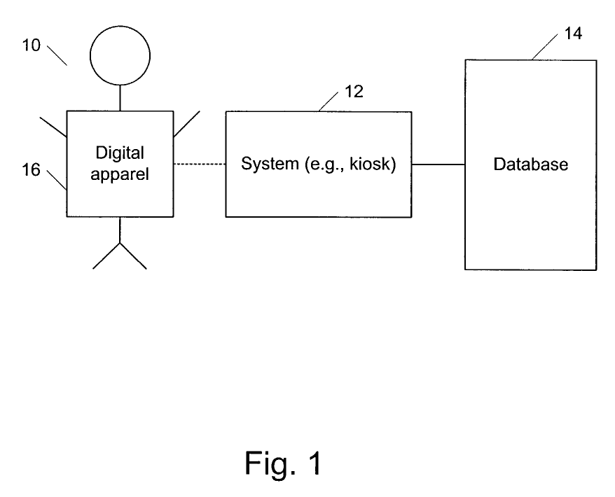

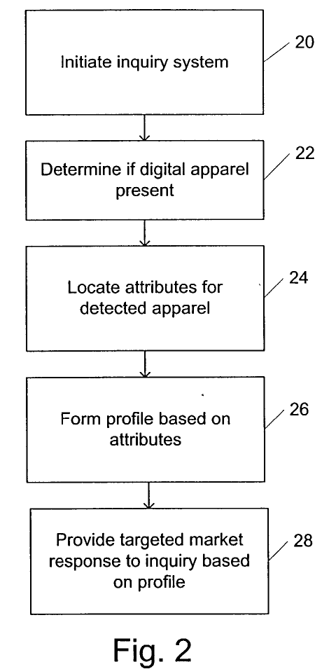

The aspects of the present invention are described with reference to the system environment diagram of FIG. 1 in conjunction with the process for performing anonymous electronic marketing flow diagram of FIG. 2. As shown in FIG. 1, the system includes a consumer 10, a processing system 12, and a database system 14. In a preferred embodiment, the consumer 10 wears one or more articles of apparel embedded with computer components, i.e., digital apparel 16, such as digital jewelry, as developed by IBM Corporation. A feature of the constituent parts and functionality of the digital apparel 16 utilized in the present invention is the ability of the digital apparel 16 to communicate wirelessly with more conventional forms of computing systems, such as processing system 12. For example, using the well-known communication techniques of RFID (radio frequency identification), the digital apparel 16 may include a transponder or tag that is read by a sensor in the processing system 12.

In the performance of anonymous electronic marketing to the consumer 10, an interactive session is initiated between the consumer 10 and the processing system 12 (step 20, FIG. 2). By way of example, the processing system 12 may be a touch-screen based-computing system, i.e., a kiosk, inside a shopping/retail center, such as a shopping mall or hotel resort. Initiation of a session would then occur when a consumer 10 first activates the system by touching the screen. Once the session has been initiated, the processing system 12 surveys the environment to detect presence of one or more articles of digital apparel 16 (step 22), e.g., through RFID. In an alternate embodiment, the detection step occurs prior to initiation of a session. By way of example, the processing system may be able to detect the presence of digital apparel on a person passing by the system and initiate an appealing audio/visual presentation in response to the detection that is intended to be tailored based upon a profile constructed from detection of the apparel, similar to that when an inquiry is made, as described hereinbelow.

When at least one digital apparel item 16 is detected, the identifying data, such as an assigned number value, an alpha-numeric value, a checksum value, etc., of the item(s) 16 is utilized by the processing system 12 to determine attributes of the item(s) 16 (step 24). In one embodiment, the processing system 12 uses the identifying data to access a database system 14, such as a server system to which it is coupled via a networking medium. The database system 14 returns attributes of the item(s) for organization by the kiosk as a profile of the consumer 10 (step 26). In an alternate embodiment, the collection of identifying data is sent to another processing system that queries the database, receives the data from the database, and builds the profile that is then returned to the kiosk. The attributes may indicate the type of item and its approximate retail cost, for example. Thus, a profile would include data that characterizes the expected spending habit of the consumer 10 based on the attributes without requiring individual and personal data disclosure by the consumer 10, i.e., the consumer 10 remains anonymous. It should be appreciated that although the presence of one article of digital apparel can be used to infer spending habits, the profile may tend to be less precise (except in the case that the article being shopped for falls into the same category as the article detected) than when multiple articles of digital apparel are detected (in which case, the complexity of building the profile may increase if the articles detected are disparate in nature and do not result in a concise categorization of the consumer)Based on the profile, the response to the consumer's inquiry is provided in a manner that is believed to match the characteristics of the consumer 10 (step 28). The profiling may be a relatively simple match between relevant price ranges of articles within their associated categories, and applied to other product categories (for example, if $75 shoes are detected, this might be considered to be in the 80th percentile of shoe cost, and therefore, a store marketing to that spending segment would be recommended ahead of other stores). When multiple articles are detected, it is possible that the articles may seem to be disparate in nature, and in those cases, the profiling system may require more complexity in order to more accurately profile the consumer's spending habits and order the results set appropriately. In such a case, the best profiling might be achieved through the use of an expert system.

Through the present invention, the inclusion of the technology and processing into a kiosk or other such customer touch point, the customer can be more effectively marketed to without any prior relationship with the vendors and without disclosing any personal information. The process better ensures that the right information reaches the target audience, since the consumer likely receives information on the availability of products and services that more closely matches their interests and needs than general marketing can achieve. The interaction is substantially non-intrusive, yet beneficial to both parties.

Although the present invention has been described in accordance with the embodiments shown, one of ordinary skill in the art will readily recognize that there could be variations to the embodiments and those variations would be within the spirit and scope of the present invention. For example, bluetooth technology may be used to allow inclusion of cell phones/personal digital assistants (PDAs) and the like in a personal area network near the kiosk for further information collection (although potentially in a limited manner for privacy and security considerations). Accordingly, many modifications may be made by one of ordinary skill in the art without departing from the spirit and scope of the appended claims.

What is claimed is:

1. A method for anonymous electronic marketing, the method comprising the steps of:
(a) detecting a presence of at least one article of digital apparel on a consumer by a processing system;
(b) utilizing data of the at least one article by the processing system to determine attributes of the at least one article;
(c) providing a profile of the consumer based on the attributes by the processing system; and
(d) providing information to the consumer based on the profile.

2. The method of claim 1 wherein the processing system comprises a kiosk, the kiosk comprising a system that accepts consumer inquiries and responds with shopping information of interest to satisfy the consumer inquiries.

3. The method of claim 2 wherein the kiosk further comprises a touch-screen sensitive computer system.

4. The method of claim 1 wherein the detecting step (a) further comprises the step of (a1) detecting presence of an RFID signal from the at least one article.

5. The method of claim 1 wherein the utilizing step (b) further comprises the step of (b1) utilizing the data to access a database and locate the attributes associated with the at least one article.

6. The method of claim 5 further comprising utilizing another processing system to access the database.

7. A system for anonymous electronic marketing, the system comprising:
a consumer wearing one or more articles of digital apparel;
a database system for storing attributes associated with digital apparel; and
at least one processing system for receiving inquiries from the consumer, for identifying presence of the one or more articles, for accessing the database system to form a profile of the consumer based on the attributes, and for responding to the inquiry with targeted market information based on the profile.

8. The system of claim 7 wherein the at least one processing system further comprises a touch-screen sensitive computer system.

9. The system of claim 7 wherein the at least one processing system identifies presence of the one or more articles by detecting presence of an RFID signal from the one or more articles.

10. The system of claim 9 wherein the RFID signal further comprises an identifying data value.

11. The system of claim 10 wherein the processing system utilizes the identifying data value to locate the attributes in the database system.

12. A method for anonymous electronic marketing, the method comprising the steps of:
(a) identifying that a consumer is wearing at least one digital apparel;
(b) determining attributes associated with the at least one digital apparel identified; and
(c) profiling the consumer based on the attributes to deliver information.

13. The method of claim 12 wherein the identifying step (a) further comprises the step of (a1) initiating an interaction session between the consumer and a processing system with detection of identifying data from the at least one digital apparel items in the processing system.

14. The method of claim 13 wherein the identifying data further comprises an identifying value assigned to each of the at least one digital apparel item.

15. The method of claim 14 wherein an RFID signal transmits the identifying data.

16. The method of claim 14 wherein the determining attributes step (b) further comprises the step of (b1) utilizing the identifying data to locate data from a database associated with the at least one digital apparel items.

17. The method of claim 16 wherein the profiling step (c) further comprises the step of (c1) determining a characterization of the consumer based on the located data.
